(19) United States
(12) Patent Application Publication
(10) Pub. No.: US 2005/0244547 A1
(43) Pub. Date: Nov. 3, 2005

(54) Flexible stick and a container therefore

(76) Inventor: Naftali Lobl, Ramat Gan (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/520,622

(22) PCT Filed: Jun. 15, 2004
(86) PCT No.: PCT/IL04/00516

§ 371 Date: Jan. 10, 2005

Related U.S. Application Data
(63) Continuation of application No. 10/463,909, filed on Jun. 18, 2003.

(30) Foreign Application Priority Data
Sep. 4, 2003 (IL) 157759

(51) Int. Cl. A23B 4/00; B65D 85/00; A21D 10/02

(52) U.S. Cl. 426/110

(57) ABSTRACT

The invention relates to a bendable stick, and a container for the stick provided with a straitening arrangement of the bent stick. The stick according to the invention could be used for many articles in a variety of configurations, the stick is made of a flexible material preferably in combination with a compact container, wherein the stick is provided with a dividable end and a retention end, for a candy or spoon or the like items, the major portion of the stick being dividable into two elongated halves by insertion into a compact container or holder, a separation device, causing separation of the elongated halves, may be provided at the bottom of the container or holder and bending thereof of at least 180 degrees during the insertion resulting from contact with inner walls of the container or holder, the stick being retained in the divided and bent configuration. The compact container or holder being further provided with a reunification device.

### FILED AND BACKGROUND OF THE INVENTION

The present invention relates to a bendable stick, and a container for the stick provided with a straitening arrangement of the bent stick.

The stick according to the invention could be used for many articles in a variety of configurations. Self-service restaurants, Supermarkets and Vending machines have long provided an economic method for selling consumer articles. Presently machines are in use for selling hot and cold beverages, cigarettes, sweets, chocolates, other foods, and many other items. Many of the articles such as lollipops are provided with a stick. Other articles such as puddings, ice creams must be provided with a small spoon or a fork others, to enable immediate consumption.

The length of a lollipop stick or a small spoon or fork is approximately 5 to 7 cm, which in many cases causes a problem of packing and vending. From the point of view of the packing the size of the stick or spoon is significant.

From the point of view of the vending machine, a lollipop is a lightweight low-cost item, which may be sticky and is covered by a paper wrapping which may be of irregular configuration. In U.S. Pat. No. 5,485,939 Tucker discloses a lollipop dispensing apparatus.

Consumers of lollipops are likely to require temporary storage thereof for example while entering a classroom or a house of prayer. If a paper wrapping thereof was provided and is still to hand said wrapping can be used for this purpose. An attractive alternative providing compact and hygienic storage is to use the original marketing container also for compact rest rage, hereafter the lollipop in its container can be conveniently held in a pocket of a child's clothing.

### OBJECTS OF THE INVENTION

It is therefore one of the objects of the present invention to obviate the disadvantages of prior art and to provide a stick which can be bent more than 180° when inserted into a compact container and will regain its original straight and substantially rigid form when removed from said container. It is a further object of the present invention to provide a compact container, which accepts items such as a lollipop or others while sharply bending the stick thereof, the container later being available to the consumer and serving as a holder for a partly consumed lollipop. Yet a further object is to provide a method for marketing and selling of products by means of a vending machine.

It should be noted that the method and means described could also be used with other packages not just spherical containers, and for products such as Ice creams, Puddings, Yogurt and the like.

### SUMMARY OF THE INVENTION

The present invention achieves the above objects by providing a stick made of a flexible material preferably in combination with a compact container, wherein said stick is provided with a dividable end and a retention end, for a candy or spoon or the like items, the major portion of said stick being dividable into two elongated halves by insertion into a compact container or holder, a separation device, causing separation of said elongated halves, may be provided at the bottom of the container or holder and bending thereof of at least 180 degrees during said insertion resulting from contact with inner walls of said container or holder, said stick being retained in said divided and bent configuration, said compact container or holder being further provided with a reunification device, whereby on opening of said container and withdrawal there from of said stick said two elongated stick halves pass through said reunification device and are firmly rejoined thereby to form a substantially straight rigid stick.

In a preferred embodiment of the present invention there is provided a stick preferably in combination with a compact container as defined above, said container being completed by attachment thereto of a discrete closure to form a housing shape readily to be used for any required purpose. In a further preferred embodiment there is provided a spoon or fork held by a holder adapted to be marked with food products.

In a most preferred embodiment of the present invention there is provided a method for marketing of items, comprising the steps:
step 1: providing a stick and preferably container as claimed in claim 1;
step 2: attaching a required item to said retention end,
step 3: optionally wrapping said item,
step 4: inserting said item into said compact container or holder by pressing said stick against said separation device to separate and bend said elongated stick halves into said container or holder sized and shaped for convenient handling,
step 5: loading a multitude of said filled containers into a vending means; or into a package of a product; and
step 6: instructing the consumer to pull said item from said container or holder, thereby reconstructing said stick as a rigid holder

Yet further embodiments of the invention will be described hereinafter.

It will thus be realized that if a substantially spherical container were to be fitted around a prior-art item, such container would be unreasonably large and expensive, and also too large for economic handling especially by a vending machine. In the novel marketing method of the present invention, the item is held in a much smaller plastic container or just a holder, which is suitable especially but not exclusively for a vending machine. Such container can be provided with a removable and replaceable cover and be retained by the consumer for hygienic storage. A known need for a bendable stick is thus served, and the packaging container thus obviates the need for the type of container disclosed by Jones in U.S. Pat. No. 5,702,742. Likewise marketing of products such as Ice creams, Puddings with a spoon being equipped with a spoon holder in a bent form.

It will further realize that the bending and reunification arrangement could be utilized with other packing rather than the described container, i.e. differed configurations of the packing.

As is known, the fiber stress on a beam, which is subjected to a bending load, is a partial function of I, the rectangular moment of inertia. Stress rises in direct proportion to I, all other factors remaining unchanged. For a round section, I is approximately 0.05d⁴, where d is the rod diameter, while for a semi-circular section of the same radius I is approximately 0.0069d⁴. In other words, the bending stress on a semi-circular section is lower by a factor of more than 7 in comparison with the bending stress on a circular section beam of the same diameter. Consequently, if a circular beam were split into two separate beams, a much greater degree of bending would be allowed and such bending will not cause permanent material deformation. When the two semi-circular halves are rejoined the mechanical properties of the resulting cylindrical-section beam are almost the same as that of a solid circular-section beam. These considerations form the basis for the present invention.

### SHORT DESCRIPTION OF DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a perspective-enlarged view of a preferred embodiment of the stick according to the invention;

FIG. 2 is a perspective, cut-in-half view of a container;

FIG. 3 is a perspective view of an item shown in its stored configuration;

FIG. 4 is an elevational view of perspective view of a further preferred embodiment of the stick;

FIG. 5 is a perspective view of the item such as a lollipop inside a container;

FIG. 6 is a container configured for easy opening and reuse,

FIG. 7 is a photographic view of a preferred stick embodiment provided with inter-engaging teeth;

FIG. 8 is an elevational view of a lollipop stored in a closed container; and

FIG. 9 is an enlarged elevational view of a stick provided with means for the retention of a candy, or similar items;

FIG. 10 is a container where the separation blade is removed.

FIG. 11 is a stand-alone bending and reunification arrangement.

### DETAILED DESCRIPTION OF THE INVENTION

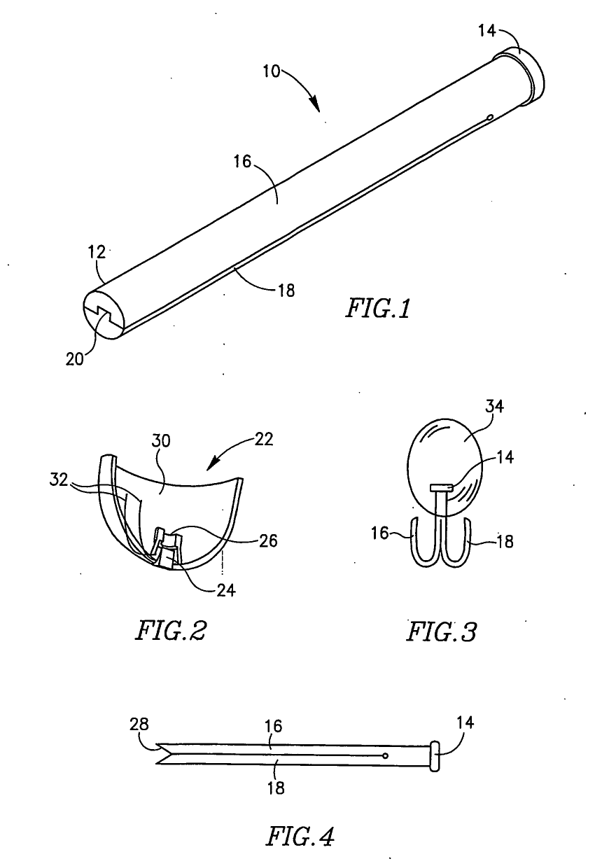

There is seen in FIG. 1 an enlarged view of a stick 10. The stick shown is of round cross-sectional area form, and is suitably made of a flexible material, for example low-density polyethylene. The stick could also be of a different cross section.

The stick 10 is preferably used in combination with a compact container 22 seen in FIG. 2. The stick is provided with a dividable end 12, and a retention end 14. The major portion of the stick 10 is dividable into two flexible elongated halves 16, 18 along most of its length. The two halves 16, 18 can be rejoined to again form the solid substantially rigid stick 10 seen in the figure. In the present embodiment the elongated halves 16, 18 are interconnected by a dovetail joint 20. The joint 20 is designed for low-pressure engagement.

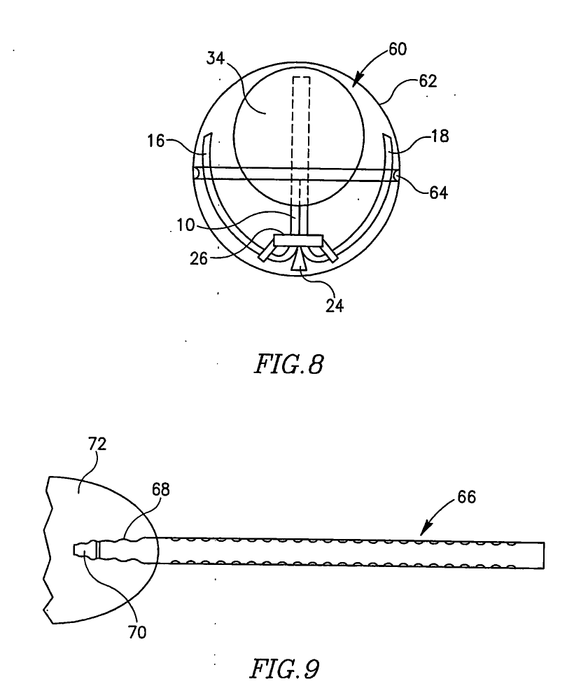

Referring now to FIG. 2, there is seen half of a compact lollipop or the like container 22, preferably provided with an internal separation device and an internal reunification device for the stick 10. Advantageously the container 22 is transparent. The separation device comprises an outward-facing wedge-shaped blade 24, which contacts the dividable end 12 when a stick 10 is loaded or reloaded into the container 22. To ensure alignment the dividable end 12 of the stick 10 is advantageously provided with a lead-in chamfer 28 as seen in FIG. 4. The container could however be produced without said separation device. The Separation could be done on assembly line during packing of the inserted item. Axial pressure of the stick 10 against the blade 24 causes separation of the elongated halves 16, 18 seen in FIG. 3. Continued feeding-in of the stick 10 extends separation over an additional length, the final configuration being seen in FIG. 8. Blade 24 could be part of an automatic packing line namely not an integral part of the container but external thereto. During feeding in, there also occurs bending of the elongated halves 16, 18 of at least 180 degrees, as seen in FIG. 3. The bending results from contact between the newly separated elongated halves 16, 18 with inner walls 30 of the compact container 22. Guide rails 32 project from the inner walls 30 are provided to ensure that the elongated halves 16, 18 extend in an orderly manner.

As seen in FIG. 3 the lollipop or the like is completed by a candy 34, which is firmly attached to the candy retention end 14 of the stick. The stick 10 is retained in the divided and bent configuration during marketing. The stick 10 remains in the described split configuration until the inserted item is pulled out of its container 22. As the stick 10 or item 34 is pulled out, the reunification device, comprising a ring 26 acts to guide and align the two elongated halves 16, 18 and apply light pressure thereto. The two elongated stick halves pass through the reunification ring 26 and are firmly rejoined thereby to form a substantially straight rigid stick 10 supporting the item 34.

With reference to the rest of the figures, similar reference numerals have been used to identify similar parts.

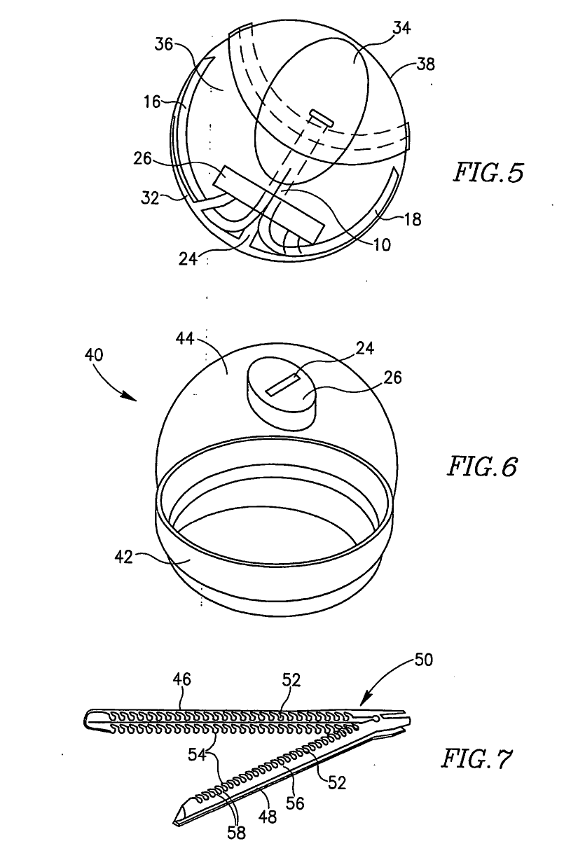

FIG. 5 illustrates a compact container 36 completed by attachment thereto of a discrete closure 38 to form a housing shaped substantially as a sphere. The container 36 is of substantially semi-spherical form and of moderate size. Thus the container 36 and its contents 10, 34 can be readily bulk loaded into and dispensed from a low-cost vending machine (not shown) having a simple feed mechanism.

Seen in FIG. 6 is a further embodiment of the container assembly 40. The discrete closure 42 of the present embodiment is a light fit on the container body 44, and is molded using a bright color. The closure 42 is readily removable and replaceable by children, and allows storage in the container assembly 40 of a partially consumed lollipop, or any other stored item.

FIG. 7. In the present embodiment the two elongated halves 46, 48 of the stick 50 are provided with multiple interlockable teeth 52 along their length. A bulge 54 at each tooth extremity is accommodated by a recess 56 between the roots 58 of a pair of similar opposing teeth projecting from the opposite elongated half of the stick.

The stick 50 is reconstructed by the interlocking of the two elongated halves 46, 48 during withdrawal from a container, for example 22 in FIG. 2. The advantage of the present embodiment lies in that the reunification ring 26, seen in FIG. 2, need not apply pressure to the outer faces of the elongated halves 46, 48. While the elongated halves are still bent, the teeth 52 of one half readily inter-engage with the teeth of the second half, whereafter straightening of the two halves 46, 48 automatically causes the interlocking of previously inter-engaged teeth. Furthermore, the recesses 56 formed between adjacent teeth further contribute to flexibility of the elongated halves. Yet a further advantage of the present embodiment is that after the teeth 52 are interlocked there can be no axial movement of one elongated half 46 relative to the second elongated half 48, thus improving rigidity.

Referring now to FIG. 8, there is seen a packaged lollipop 60 or similar item comprising the lollipop candy 34 retained on a stick 10. The lollipop 60 is hermetically encapsulated in a plastic container 62 intended for single use only and shaped substantially spherically for convenient handling in a vending machine. The stick 10 is held in its bent form while inside the container 62. The container 62 is opened before consumption by cutting or breaking a peripheral break line 64. Thus there is eliminated any chance of contamination. Optionally shelf life can be increased by filling the container 62 with an inert gas other than air, for example nitrogen, or by sealing the container under vacuum.

Turning now to FIG. 9, there is seen a further embodiment of a stick 66. The stick is further provided with form irregularities 68 proximate to the retention end 70. As the user pulls the candy 72 out of the container 22 seen in FIG. 2, it is important to enhance resistance to unwanted withdrawal of the stick 66 from the candy 72.

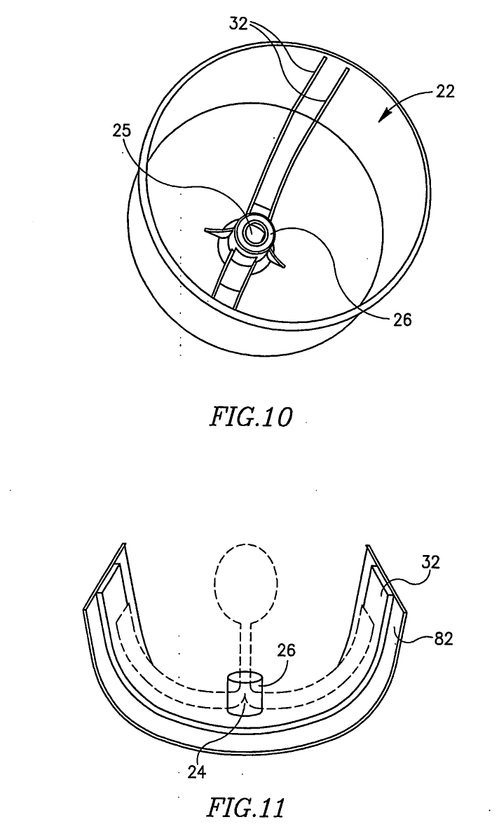

FIG. 10 illustrates container 22 reunification ring 26 guide 32 however without separation blade 24.

The separation is preformed by an automatic packing machine having a separation blade, which is inserted into container 22 via apparatus 25. Guide rails 32 project from the inner wall of container 22 to ensure that the two halves extend in an orderly manner.

FIG. 11 illustrates a stand-alone unit which comprises a bent part 82 provided with guide rails 32, a reunification ring 26 and a separation blade 24. Such stand alone unit could be incorporated in many packings and configurations, for instance as a small spoon or fork to be used with Ice creams, Puddings and the like.

The present invention also provides a method for automatic marketing of items, which comprises the following steps.
step 1: providing a divided stick and a compact container or holder as described with reference to FIGS. 2, 7 and 11;
step 2: attaching an item to the retention end;
step 3: optionally wrapping the item;
step 4: inserting the item into the container or holder by pressing the divided end of the stick against the separation device to separate and bend the elongated stick halves inside the container or holder sized and shaped for convenient handling;
step 5: bulk loading a multitude of the filled containers into a vending machine or location, and
step 6: instructing the consumer to pull the item from the container, thereby reconstructing the stick as a rigid holder

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

1. A stick made of a flexible material preferably in combination with a compact container or holder, wherein said stick is provided with a dividable end and a retention end, the major portion of said stick being dividable into two elongated halves by insertion into a compact container or holder which may be provided with a separation device, causing separation of said elongated halves, and bending thereof of at least 180 degrees during said insertion resulting from contact with inner walls of said container or holder, an item being firmly attached to said retention end, said stick being retained in said divided and bent configuration, said compact container or holder being further provided with a reunification device, whereby on opening of said container or holder and withdrawal there from of said item said two elongated stick halves pass through said reunification device and are firmly rejoined thereby to form a substantially straight rigid stick supporting said item.

2. The stick as claimed in claim 1 wherein the container or holder is provided with a separation device in a form of a blade.

3. The stick as claimed in claim 1 wherein the reunification device has a cross section as of the stick.

4. The stick in combination with a compact container or holder as claimed in claim 1, said container or holder being completed by attachment thereto of a discrete closure to form a housing shape readily dispensed by a simple vending machine.

5. The stick and container as claimed in claim 4, wherein said closure is readily removable and replaceable by children to allow storage of a partially consumed.

6. The stick and container as claimed in claim 1, wherein said container is transparent.

7. The stick as claimed in claim 1, wherein said two elongated stick halves are provided with multiple interlockable teeth along their length, a bulge at each tooth extremity being accommodated by a recess between the roots of a pair of similar opposing teeth projecting from the opposite elongated half of said stick, as said stick is reconstructed by the interlocking of said two elongated halves during withdrawal from said container.

8. The stick as claimed in claim 1, being made of low-density polyethylene.

9. A packaged lollipop comprising the lollipop candy, retained on a stick as claimed in claim 1, and being encapsulated in a disposable plastic container shaped for convenient handling in a vending machine, said stick being held in its bent form while inside said container.

10. The stick as claimed in claim 1, being further provided with form irregularities at said item retention end to enhance resistance to unwanted withdrawal of said stick from said item.

11. A stick substantially as described hereinbefore and with reference to the accompanying drawings.

12. A method for the automatic marketing of items, comprising the steps:
step 1: providing a stick and container as claimed in claim 1;
step 2: attaching an item to said retention end;
step 3: optionally wrapping said item;
step 4: inserting said item into said compact container by pressing said stick against said separation device to separate and bend said elongated stick halves into said container sized and shaped for convenient handling in a vending machine;
step 5: loading a multitude of said filled containers into a vending machine; and
step 6: instructing the consumer to pull said item from said container, thereby reconstructing said stick as a rigid holder.
